(19) United States
(12) Patent Application Publication
(10) Pub. No.: US 2026/0011844 A1
(43) Pub. Date: Jan. 8, 2026

(54) CELL SEPARATING ELEMENT HAVING REGIONS OF DIFFERENT HARDNESS, BATTERY MODULE AND METHOD FOR PRODUCING A BATTERY MODULE

(71) Applicant: AUDI AG, lngolstadt (DE)

(72) Inventors: Carsten LORENZ, Reichertshofen (DE); Eduard MAIN, Buxheim (DE); Julius RAUSCH, Heilbronn (DE)

(73) Assignee: AUDI AG, lngolstadt (DE)

(21) Appl. No.: 19/255,284

(22) Filed: Jun. 30, 2025

(30) Foreign Application Priority Data
Jul. 3, 2024 (DE) 102024118886.3

(51) Int. Cl. H01M 50/242; H01M 50/11; H01M 50/209; H01M 50/249; H01M 50/291; H01M 50/293

(52) U.S. Cl. CPC H01M 50/242; H01M 50/11; H01M 50/209; H01M 50/291; H01M 50/293; H01M 50/249

(57) ABSTRACT

A cell separating element for arrangement between two battery cells. The cell separating element is elastically compressible with respect to a first direction and, in an uncompressed state, has a maximum first thickness of the cell separating element in at least one first region and a maximum second thickness of the cell separating element in at least one second region, which are different, and in a state of the cell separating element in which the at least one first region and the at least one second region are compressed to an identical maximum thickness with respect to the first direction, the restoring forces caused by the compression of the cell separating element in the at least one first region and in the at least one second region are different.

### FIELD

The invention relates to a cell separating element for arrangement between two battery cells of a battery module, the cell separating element being designed as a solid body and having two outer sides which lie opposite one another with respect to a first direction and the distance between which in the first direction defines a thickness of the cell separating element, the cell separating element being divided into at least one first region and at least one second region in a second direction perpendicular to the first direction, and wherein the cell separating element is elastically compressible with respect to the first direction in the at least one first region and in the at least one second region. Furthermore, the invention also relates to a battery module having such a cell separating element and to a method for producing a battery module.

### BACKGROUND

In batteries or battery modules, for example for motor vehicles, cell separating elements are often positioned between the battery cells. In a cell stack with multiple battery cells arranged next to one another in a stacking direction, such a cell separating element can be positioned between each two such battery cells arranged adjacent to one another in the stacking direction. Cell separating elements can perform different tasks depending on the application. For example, they can be used to isolate the battery cells from each other, especially for thermal insulation, or for so-called swelling compensation. Battery cells typically swell and shrink during charging and discharging, and also swell over their lifetime.

Often, the aim is to design cell separating elements in such a way that they counteract such swelling with a force that is as homogeneous as possible across the surface.

EP 3 790 097 A1 describes a structure with convex-shaped pouch cells and cell separating elements arranged between them, geometrically adapted to the second direction. The aim of this is to ensure that the force on the respective regions of the battery cells is more evenly distributed.

EP 4 084 199 A1 describes a battery module with multiple cells and buffer pads arranged between them. These can have different levels of hardness and elasticity in different regions.

Such cell separating elements are particularly well adapted to battery cells with different swelling behavior in certain regions. However, the formation of a cell separating element with regions of different hardness and/or elasticity properties, e.g. through different materials, also makes the production of such a cell separating element more complex and expensive.

### SUMMARY

The object of the present invention is to provide a cell separating element, a battery module, a battery and a method which enable the provision of a cell separating element with locally the best possible adapted swelling properties in the most simple and efficient way.

This object is achieved by a battery module and a method having the features according to the respective independent claims. Advantageous embodiments of the invention are the subject matter of the dependent claims, the description, and the figures.

A cell separating element according to the invention for arrangement between two battery cells of a battery module is formed as a solid body and comprises two outer sides which lie opposite one another with respect to a first direction, the distance of which in the first direction defines a thickness of the cell separating element, and wherein the cell separating element is divided in a second direction perpendicular to the first direction into at least one first and at least one second region. In this case, the cell separating element is elastically compressible in the at least one first and in the at least one second region with respect to the first direction, wherein in an uncompressed state of the cell separating element, a maximum first thickness of the cell separating element in the at least one first region and a maximum second thickness of the cell separating element in the at least one second region are different, and wherein in a state of the cell separating element in which the at least one first region and the at least one second region are compressed to an equal maximum thickness with respect to the first direction, restoring forces respectively caused by the compression of the cell separating element in the at least one first and in the at least one second region are different.

The invention is based on the finding that different elasticity properties or different hardnesses in different regions of a cell separating element can be provided not only by different material properties or material characteristics, but also, for example, by the cell separating element being compressed to different degrees in certain regions when installed, which in turn can be provided by the cell separating element being of different thicknesses in these regions when uncompressed. If the cell separating element therefore has the first region and the second region which, in the uncompressed state of the cell separating element, have a different maximum thickness from one another, and if the cell separating element is then compressed, for example, to a constant thickness, i.e. the cell separating element subsequently has the same thickness in all regions after compression, then the region of the at least two regions which has the greater maximum thickness in the uncompressed state is correspondingly more strongly compressed in the compressed state of the cell separating element than the other of the at least two regions with the smaller thickness in the uncompressed state of the cell separating element. This automatically results in higher restoring forces in the more strongly compressed region than in the other region of the at least two regions that is less strongly compressed or not compressed at all. Thus, in the installed state of the cell separating element, regions with different degrees of hardness can advantageously be provided, wherein this can simultaneously be provided in a particularly simple manner by a specific geometric design of the cell separating element, namely with regions that have a different thickness, without necessarily having to provide different materials or material combinations or material properties or the like in these regions. In particular, it is possible to form the cell separating element even from a uniform material, i.e. no different materials or material compositions need to be provided for the cell separating element in the different regions. This means that the cell separating element can be manufactured in a particularly simple and efficient manner. Differently thick regions of the cell separating element can be provided in a simple manner, for example by producing the cell separating element in an injection molding process and/or extrusion process.

Since the cell separating element is compressible, in particular elastically compressible, in the first and second region, it is possible, on the one hand, to provide regions of different hardness in the compressed state of the cell separating element and in the properly installed state of the cell separating element. On the other hand, the compressible design of the cell separating element makes it possible to give the adjacent cells the opportunity to swell without the installation space of the cell stack itself being significantly increased or even increased at all in the stacking direction.

The fact that the cell separating element is designed as a solid body can be understood in such a way that the volume of the cell separating element, which is enclosed by a surface of the cell separating element that delimits the cell separating element in all directions outwards, is completely filled with one or more materials, wherein the one or more materials can optionally also be a foam material, namely a porous material with pore-shaped cavities. In particular, a solid body should not be a cell separating element with one or more cavities enclosed between two plates or walls or foils.

In principle, the cell separating element can be divided into more than just the two regions, namely the first region and the second region, in the second direction and/or in a third direction which is perpendicular to the first and second directions. It is preferred if the cell separating element is compressible, in particular elastically compressible, in all regions encompassed by it or the cell separating element as a whole at least in the first direction. If the cell separating element has more than two regions, one or more optional further regions of the cell separating element in the uncompressed state may also have a maximum thickness different from the maximum first and second thicknesses or have a maximum thickness equal to the first or second maximum thickness. In other words, the cell separating element can also comprise different regions of equal thickness in the uncompressed state.

The at least one first region and the at least one second region are arranged next to one another with respect to the second direction. These do not necessarily have to be directly adjacent to each other, but they can be. With respect to the first direction, the respective at least one first and at least one second regions can extend over the entire cell separating element. However, this does not necessarily be provided.

The thickness of the cell separating element as such and in particular in each of the regions encompassed by the cell separating element should be defined in the first direction.

If the thickness of the cell separating element is constant within a certain region, e.g. the first or second region, in the uncompressed state, this represents the maximum thickness defined for this region. If the thickness is not constant within the region concerned, the maximum thickness is understood to be the largest dimension of the cell separating element in the first direction relative to that region.

The cell separating element is preferably used in a battery module with prismatic battery cells or pouch cells. The battery module can be designed in such a way that a space is created between the two battery cells arranged in the stacking direction, which intermediate space is essentially cuboid-shaped in a non-swollen state of the battery cells, in particular at the beginning of the service life of the battery cells. The cell separating element is then arranged in such a cuboid-shaped intermediate space with respect to its preferred installation position and completely fills this intermediate space in the stacking direction, which corresponds to the first direction defined above with respect to this preferred installation position of the cell separating element in the battery module, and can largely or almost completely or also completely fill this intermediate space perpendicular to the stacking direction, for example in the second direction and/or also in a third direction perpendicular thereto. The battery cells can swell during charging and over their lifetime, bulging in the middle, for example. In such a state of the battery cells, the intermediate space then has a geometry that is concavely curved inwards on both sides with respect to the first direction. Due to its elastically compressible properties, the cell separating element can adapt to this geometry completely or at least partially. If the cell separating element is arranged as intended in such a battery module, in particular in such an intermediate space between two battery cells, the respective outer sides of the cell separating element lie flat against the adjacent cell sides of the adjacent two battery cells, in particular in the non-swollen state of the battery cells and preferably also in a swollen state of the battery cells. This is possible due to the elastically compressible properties of the cell separating element, as this simply allows the region with the greater thickness to be compressed more than the region with the lesser thickness, so that despite these different thicknesses in the uncompressed state, a flat contact with the adjacent cell sides is possible.

With regard to the intended use of the cell separating element in a battery module, the outer sides of the cell separating element are in contact with those cell sides of the adjacent battery cells which represent the largest sides of the battery cells in terms of area. Furthermore, it is preferred that the geometry of the outer sides of the cell separating element or the geometry of a base region of the cell separating element, viewed in a plan view in the first direction, corresponds to the geometry of the cell sides of the adjacent battery cells, i.e. is preferably substantially rectangular.

Furthermore, the cell separating element is preferably designed such that its (global) maximum thickness is significantly smaller than its other dimensions, even in the uncompressed state of the cell separating element. The cell separating element can therefore have, for example, a height in the second direction and a length in a third direction perpendicular thereto, both of which are greater than a maximum thickness of the cell separating element. Battery cells in particular, such as prismatic battery cells, bulge more in the center than in the edge regions during their swelling. It is therefore particularly advantageous that the cell separating element described can be used to provide different force levels across the surface in the different regions. Which regions of the cell are ideally opposed by which forces, which can be realized by the restoring forces provided in the different regions when the cell separating element is compressed, depends on the cell and its properties, for example on the cell chemistry. For example, the “harder” region of the cell separating element, i.e. the region with the greater maximum thickness in the uncompressed state, can be arranged centrally and surrounded by the region with the smaller maximum thickness, or this can be located on both sides of the central region with respect to the second direction. However, it can also be provided that the central region is less hard than the further outer regions with respect to the second or third direction. However, the cell separating element can be easily adapted geometrically to a wide variety of conditions and requirements simply by means of its thickness. For example, the cell separating element can be thicker in a central region than in its edge regions or vice versa.

In an advantageous embodiment of the invention, the thickness of the cell separating element varies in steps in the second direction in the uncompressed state of the cell separating element. In the uncompressed state, the cell separating element can therefore have a constant first thickness across the first region and a constant second thickness across the second region. The same applies to optional additional regions of the cell separating element. The respective thicknesses then correspond to the maximum first thickness and the maximum second thickness, respectively. This allows for a particularly simple design of the respective different regions of the cell separating element, since the thickness within the respective regions does not have to vary too.

In an advantageous embodiment of the invention, the thickness of the cell separating element varies in steps in the second direction in the uncompressed state of the cell separating element. By continuously varying the thickness, continuous transitions can be created with regard to the restoring forces in the compressed state of the cell separating element. For example, the two outer sides of the cell separating element can be concave or convex. This can refer to the geometry of the outer sides, for example, only with respect to the second direction or alternatively also with respect to the further third direction, which is perpendicular to the first and second directions.

According to a further advantageous embodiment of the invention, in the uncompressed state of the cell separating element, the thickness of the cell separating element in the second direction is symmetrical with respect to a center of the cell separating element defined with respect to the second direction. More precisely, the thickness of the cell separating element runs symmetrically from this defined center of the cell separating element to the two edge regions of the cell separating element with respect to the second direction. The cell separating element can, for example, have a maximum thickness in the middle with respect to the second direction, and a smaller thickness in the edge regions with respect to the second direction, or vice versa. Since, as already mentioned above, battery cells often bulge in the middle, it is very advantageous to design the cell separating element symmetrically with respect to such a center, at least with respect to the second direction. This means that the cell separating element is particularly well adapted to the often symmetrical geometric swelling properties of a battery cell.

The cell separating element can, for example, be divided into three regions with respect to the second direction, for example a central first region and two second regions which adjoin the first region in and opposite to the second direction. The maximum first thickness in the first region then differs in the uncompressed state of the cell separating element from the respective maximum second thicknesses in the second regions, wherein the two respective maximum second thicknesses in the second regions can be and are preferably the same. In the second direction, the cell separating element can also be divided into more than just three regions, for example into five regions. These can also be arranged symmetrically with respect to the center in the second direction and formed with respect to their thicknesses.

Nevertheless, it is also conceivable that the thickness of the cell separating element, starting from an edge of the cell separating element, only increases in some regions in the second direction and does not decrease. The thickness can therefore increase from region to region in the second direction or decrease from region to region in the second direction. Other asymmetric thickness variations are also conceivable.

According to a further advantageous embodiment of the invention, in the uncompressed state of the cell separating element, the thickness of the cell separating element varies in a third direction perpendicular to the first and second directions, in particular symmetrically with respect to the center of the cell separating element defined in the third direction. The thickness of the cell separating element can therefore vary not only in the second direction relative to its uncompressed state, but also in the third direction. This provides the same advantageous adjustment options in the third direction as already described with reference to the second direction.

The cell separating element can therefore be divided into several regions in a completely analogous manner with regard to the third direction, each of which is assigned different maximum thicknesses in the uncompressed state of the cell separating element. The cell separating element can be divided in the third direction, for example, into only two regions or also into three regions, four regions, five regions, etc. In particular, the same embodiments as already described with regard to the second direction can also apply to the third direction.

According to a further advantageous embodiment of the invention, the at least one first region and the at least one second region of the cell separating element are formed from the same material with the same material properties. This simplifies the production of the cell separating element enormously. This may particularly also apply if the cell separating element comprises more than just the two regions. In other words, the cell separating element as a whole can be formed from the same material with the same material properties. The different restoring forces in the installed state of the cell separating element can then be realized in a simple manner (only) by the compression levels resulting from the different thicknesses in the individual regions. For the production of the cell separating element, in particular for its material, a plastic material, in particular a plastic foam, and/or a metal foam, and/or a material comprising cork are particularly suitable. The cell separating element may comprise one or more of the materials mentioned or consist of one of these materials mentioned. This means that different regions of the cell separating element do not have to be made of different materials. Foams, such as plastic foams or metal foams, can be used to easily provide an elastically compressible cell separating element. In addition, the properties of the cell separating element with regard to its elastic compressibility can be easily adjusted, for example, via the porosity of the corresponding foam, for example the plastic foam or metal foam. This porosity does not necessarily have to be different in different regions. Porosity can be understood as the pore density of a foam and/or the average pore size and/or the degree of foaming of the material or, in general, also a property relating to the pores, in particular a size and/or number of pores and/or density of the pores or of the foam material. However, there are also non-foamed materials, such as cork, which have very good elastic compressible properties.

In addition, the material may also comprise a granulate and a binder. The granulate particles can be bonded together with the binder. Suitable granules include plastic granules and/or cork granules. Material properties can be adjusted, for example, via the binder used and/or the grain size of the granulate, wherein the grain size can in turn refer to an average size or grain size of the granulate.

Although the formation of the cell separating element from a uniform material with uniform material properties is particularly simple and advantageous, it is nevertheless possible to provide different materials and/or material properties in certain regions. For example, a kind of fine-tuning of the hardness levels in the different regions can be provided in a simple way.

Accordingly, it represents a further advantageous embodiment of the invention if the at least one first and second region of the cell separating element are each formed from the same material with at least one different material property, in particular comprising a foam with a different porosity as the at least one different material property, or comprising a granulate, in particular a cork granulate and/or plastic granulate, with a different grain size as the at least one different material property.

The material from which the at least one first and the at least one second region as well as optional further regions of the cell separating element are made can therefore basically be the same, wherein the material properties such as porosity or degree of foaming and/or grain size can differ in the respective regions. This has the advantage that the different regions can be connected particularly easily during the production of the cell separating element or that different regions of the cell separating element or the cell separating element as a whole can be produced in the same process step, and yet different material properties can be realized in the different regions.

According to a further advantageous embodiment of the invention, the at least one first and second region of the cell separating element are each formed from a material with at least one different material component. It is also conceivable that the regions of the cell separating element are made of a different material or have a different material composition. For example, the regions can be formed from a different plastic material, in particular a foamed different plastic or a different metal, in particular a foamed different metal, or from granules with a binder, wherein the binders and/or optionally also the granule material can differ from one another. However, the same granulate material but different binding agents can also be used.

As a result, different properties can be provided in the different regions in an even more flexible way. The described embodiments with regard to the formation of the regions can also be combined with each other in any way.

Furthermore, the invention also relates to a battery module having a cell separating element according to the invention or one of its embodiments as well as with at least two battery cells, between which the cell separating element is arranged.

The battery cells can be formed as lithium-ion cells, for example. The battery cells can in particular be prismatic battery cells or pouch cell. The battery module, for example, can comprise a cell stack with multiple battery cells arranged next to one another in a stacking direction, wherein a cell separating element according to the invention or a cell separating element according to an exemplary embodiment of the invention can be arranged between two respective battery cells next to one another in the stack direction. Depending on the number of battery cells, the battery module can also include several cell separating elements.

Furthermore, the invention also relates to a battery having a battery module according to the invention or one of its embodiments. Moreover, the invention also relates to a motor vehicle having a battery module according to the invention or one of its embodiments or having a battery according to the invention or any one of its embodiments. The battery can be designed, for example, as a high-voltage battery, in particular as a traction battery for the motor vehicle.

The motor vehicle according to the invention is preferably designed as an automobile, in particular as a passenger car or truck, or as a passenger bus or motorcycle.

Furthermore, the invention also relates to a method for producing a battery module according to the invention or one of its embodiments. In this case, the cell separating element is arranged between the two battery cells in such a way that the cell separating element is compressed with respect to the first direction in such a way that the restoring forces caused by the compression of the cell separating element in the at least one first region and the at least one second region are different.

The invention also includes developments of the battery module according to the invention, and of the method according to the invention which have features as already described in connection with the cell separating element according to the invention and its developments. For this reason, the corresponding developments of the battery module according to the invention and of the method according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic cross-sectional representation of a cell separating element according to an exemplary embodiment of the invention;

FIG. 2 shows a schematic representation of a battery module having a cell separating element according to an exemplary embodiment of the invention;

FIG. 3 shows a schematic representation of a battery module having multiple battery cells and multiple cell separating elements according to an exemplary embodiment of the invention;

FIG. 4 shows a schematic illustration of a cell separating element in a top plan view according to a further exemplary embodiment of the invention.

FIG. 5 shows a schematic illustration of a cell separating element in a top plan view according to a further exemplary embodiment of the invention.

FIG. 6 shows a schematic illustration of a cell separating element in a top plan view according to a further embodiment of the invention;

FIG. 7 shows a schematic illustration of a cell separating element in a top plan view according to a further exemplary embodiment of the invention.

FIG. 8 shows a schematic illustration of a cell separating element in a top plan view according to a further exemplary embodiment of the invention; and

FIG. 9 shows a schematic illustration of a cell separating element in a top plan view according to a further exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

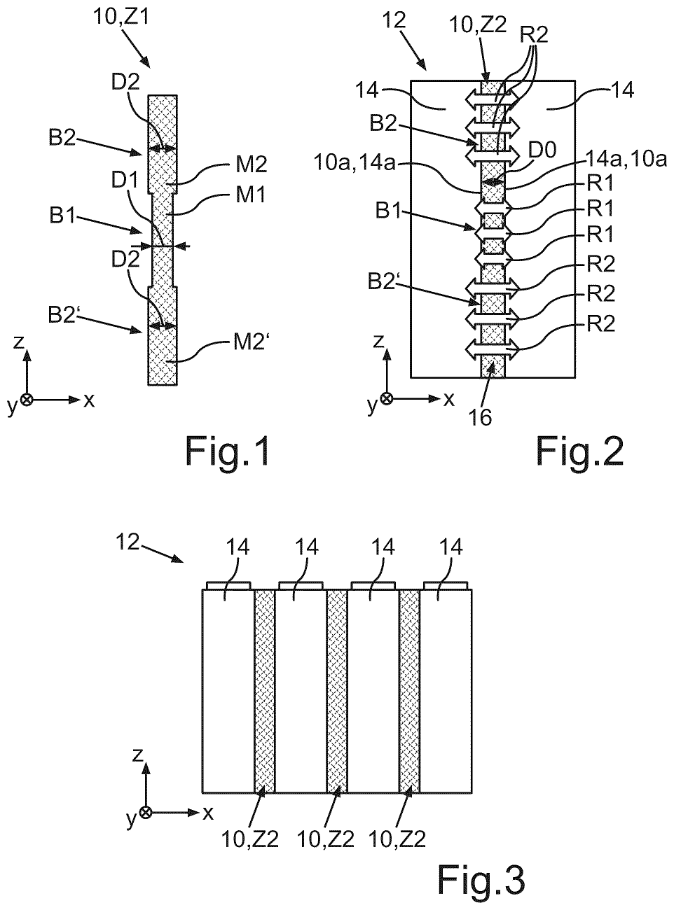

FIG. 1 shows a schematic cross-sectional representation of a cell separating element 10 according to an exemplary embodiment of the invention. A thickness of the cell separating element 10 is defined with respect to the x-direction shown here, which corresponds to the previously mentioned first direction. The cell separating element 10 is also divided into multiple regions in the z-direction shown here, in the present example into a first central region B1 and two outer regions B2, B2′. The cell separating element 10 is also shown here in a non-compressed state Z1 and in particular in a non-installed state Z1. In this state, the cell separating element 10 has different thicknesses D1, D2 in different regions B1, B2, B2′. In this example, the thickness D2 in the outer regions B2, B2′ is the same, while the thickness D1 in the central region B1 is smaller than the respective thickness D2 in the outer regions B2, B2′. The first region B1 can also be made of a first material M1, the second region B2 of a second material M2 and the third region B2′ of a third material M2′. The materials M1, M2, M2′ can be the same or they can be different from each other. In general, it is very advantageous if one or more of these materials M1, M2, M2′ comprises a plastic, for example a plastic foam or a plastic granulate or a metal foam or cork, for example a cork granulate. Granular materials, such as materials with plastic granules and/or cork granules, may also contain a binder. It is also conceivable that the regions B1, B2, B2′ differ with regard to the degree of foaming and/or the porosity and/or the grain size of the granulate and/or a material component, for example a binder. But even if the regions B1, B2, B2′ are made of the same material with the same material properties, different restoring forces R1, R2 can advantageously be provided in the different regions B1, B2, B2′ when they are in a compressed state and, for example, installed in a battery module 12 (see FIG. 2) due to their different thicknesses D1, D2, as is illustrated, for example, in FIG. 2.

FIG. 2 shows a schematic representation of a battery module 12, which comprises, by way of example, two battery cells 14, for example prismatic battery cells 14, which are arranged next to one another in a stacking direction x, and in the space 16 between which a cell separating element 10 according to an embodiment of the invention is located. The cell separating element 10 can be designed as previously described to FIG. 1, for example. The cell separating element 10 is therefore in an installed state Z2 or in a compressed state Z2. In this example, the cell separating element 10 is compressed with respect to the x-direction in such a way that it has, for example, a constant thickness D0. This can correspond to the minimum thickness of the cell separating element 10 in the uncompressed state Z1, for example to the first thickness D1, or can be smaller than the first thickness D1. Since the intermediate space 16 is essentially cuboid-shaped, at least in a non-swollen state of the battery cells 14, or the mutually facing cell sides 14a of the battery cells 14, viewed in the x-direction over their surface, have an essentially equal distance, which corresponds, for example, to the thickness D0, the cell separating element 10 is compressed to a correspondingly different extent in its different regions B1, B2, B2′. In particular, the cell separating element 10 is less compressed in the first region B1 than in the other two regions B2, B2′. This results in correspondingly higher restoring forces R2 in the respective second and third regions B2, B2′ than in the first region B1. Thus, ultimately, different degrees of hardness can be provided in the different regions B1, B2, B2′ depending on the formation of their thickness D1, D2 without the need to form the regions B1, B2, B2′ themselves from different materials and/or with different material properties. This simplifies the design of the cell separating element 10 and its manufacture. Nevertheless, due to the elastically compressible properties of the cell separating element 10, its outer sides (10a, 10b), which delimit the cell separating element 10 in and against the x-direction, can lie flat against the cell sides 14, 14b.

In this example, the two outer regions B2, B2′ are designed with the same thickness D2. This does not necessarily have to be the case. These two regions B2, B2′ can also differ in terms of their thickness and again in terms of their thickness D2 from the first region B1. It is also not necessary for three regions B1, B2, B2′ to be provided, but only two different regions can be provided or more than three. The thickness D1, D2 also varies in the uncompressed state Z1 of the cell separating element 10 with respect to the second direction in the present example in a step-like manner. However, a continuous transition is also conceivable.

In this example, the restoring forces R1, R2 resulting from the cell separating element 10 in the installed state Z2 are dimensioned such that the first restoring force R1 is smaller than the second restoring force R2 in the respective outer regions B2, B2′. Thus, the central region B1 offers a lower hardness and thus a lower resistance during cell swelling and thus allows the adjacent cells 14 the opportunity for targeted swelling. This is beneficial for most battery cells, especially prismatic lithium-ion cells. However, another embodiment would also be conceivable, according to which, for example, the cell separating element 10 is designed with regard to its thickness such that it has a greater thickness in the central region B1 in the uncompressed state Z1 than in the respective edge regions B2, B2′.

FIG. 3 once again shows a schematic representation of a battery module 12 which comprises more than two battery cells 14 and correspondingly more than one cell separating element 10. Such a cell separating element 10 can be arranged between every two battery cells 14 arranged adjacent to each other in the stacking direction.

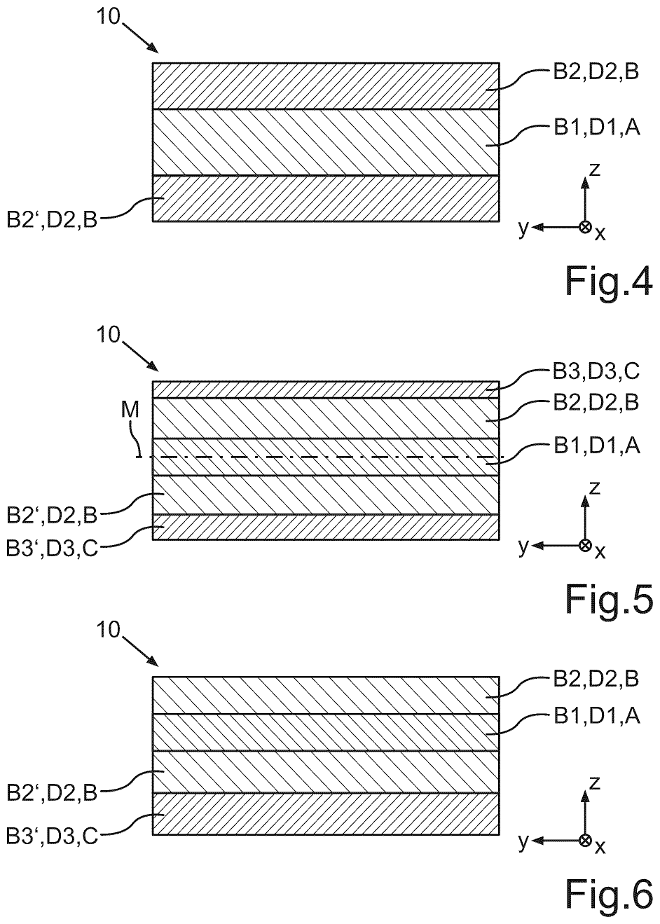

In addition, the thickness of the cell separating element 10 in the uncompressed state Z1 can vary not only in the z-direction shown, but additionally or alternatively also in the y-direction shown. Further variants of such a cell separating element 10 with regard to the formation of different regions with different thicknesses will be explained in more detail with reference to FIG. 4 to FIG. 9.

In FIGS. 4 to 9, a cell separating element 10 is shown in a plan view of the x-direction shown. The cell separating element 10 can be subdivided into at least two or more regions, in particular in the y-direction and/or z-direction. The different regions are designated B1, B2, B2′, B3, B3′. A thickness of the cell separating element 10 in the x-direction can be assigned to each of these regions, the respectively assigned thicknesses being designated D1, D2, D3. Differently designated thicknesses D1, D2, D3 should be dimensioned differently in these examples. This results in different restoring forces for the respective regions in the installed state Z2, analogous to that already described in FIG. 2. Accordingly, different hardness levels or hardnesses can be assigned to the different regions, which are designated A, B, C in this case. Differently designated degrees of hardness differ in their hardness. The degrees of hardness A, B, C can be understood as relating to the installed state Z2 of the cell separating element 10, so that a region of the cell separating element 10 which, in the installed state of the cell separating element 10, provides a higher restoring force due to its compression, has a correspondingly higher degree of hardness and thus a greater hardness than a region which, due to its lower compression in the installed state Z2 of the cell separating element 10, provides a lower restoring force in relation to the y-direction. The hardness grades A, B, C can therefore also represent different restoring forces in the respective regions in the installed state Z2 of the cell separating element 10.

In the example shown in FIG. 4, the cell separating element 10 comprises three regions B1, B2, B2′, wherein the outer regions B2, B2′ are formed with an equal thickness D2 and correspondingly with an equal degree of hardness B, which in this example differs from the degree of hardness A of the first region B1 with the first thickness D1, for example being greater or alternatively being smaller. In this example, the thickness of the cell separating element 10 varies only in the z-direction and not in the y-direction. In other words, the thickness of the cell separating element 10 in the y-direction is constant in each of the regions B1, B2, B2′.

According to FIG. 5, the cell separating element 10 is again subdivided in the z-direction, in particular only in the z-direction, into several regions, namely in this example into five regions B1, B2, B3, B2′, B3′, wherein the thicknesses D2 in the respective second regions B2, B2′ and also the resulting degrees of hardness B are the same, and the thicknesses D3 in the third regions B3, B3′ should also be the same in the present example, resulting in a corresponding degree of hardness C. In the first region B1, the cell separating element 10 has a first thickness D1 in the uncompressed state Z1, which results in a hardness degree A in the installed state Z2. Hardness level A can be lower than hardness level B, which in turn can be lower than hardness level C. Other configurations are also conceivable. In this example, as well as in the example described in FIG. 4, the arrangement of the regions with regard to their degrees of hardness A, B, C and in particular with regard to their thicknesses D1, D2, D3 in and opposite to the z-direction is symmetrical with respect to a center M of the cell separating element 10 with respect to the z-direction.

According to the example shown in FIG. 6, the cell separating element 10 is subdivided in the z-direction into four regions, namely a first region B1 with the thickness D1 and the hardness A, two second regions B2, B2′, each with the same thickness D2 and hardness B, and a further third region B3′ with a third thickness D3 and a corresponding hardness C. In the example shown here in FIG. 6, the arrangement of the regions with regard to their hardness A, B, C and in particular with regard to their thicknesses D1, D2, D3 in and opposite the z-direction is not symmetrical with respect to a center M of the cell separating element 10 with respect to the z-direction. In other words, an asymmetrical structure of the cell separating element 10 with regard to its regions with different thicknesses is also possible.

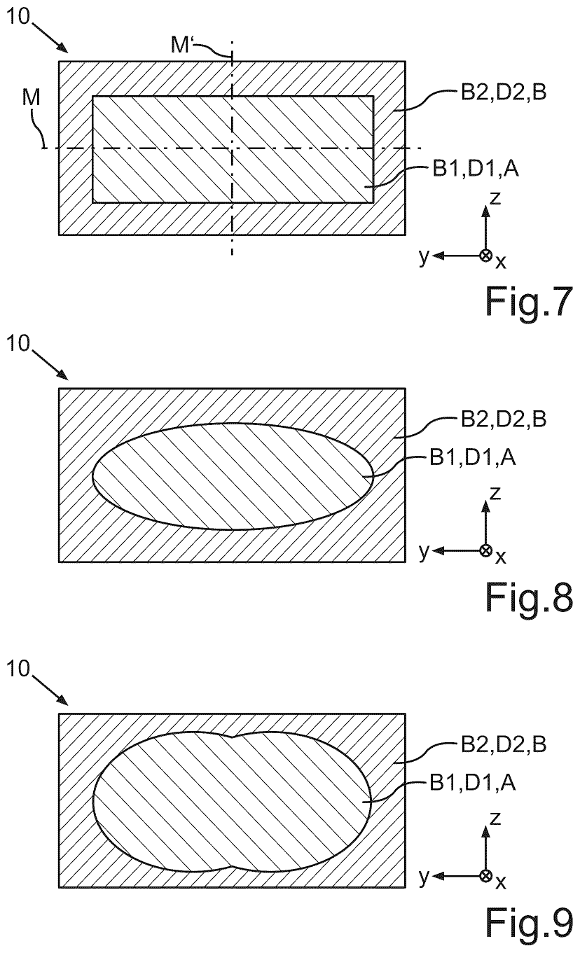

FIG. 7 shows a schematic illustration of a cell separating element 10 according to a further exemplary embodiment of the invention. In this case, it is divided into two regions B1, B2, with the first region B1 being framed by the second region B2. The thickness of the cell separating element 10 thus varies in the uncompressed state Z1 in the present example both in the z-direction and in the y-direction. In other words, in the present example, the cell separating element 10 can be divided into these regions B1, B2 both in the second direction and in the y-direction. Furthermore, in this example, the structure of the cell separating element 10 is symmetrical with respect to the arrangement of its regions B1, B2 with the different thicknesses D1, D2, from which different degrees of hardness A, B result in the installed state Z2, not only with respect to the center M, which is defined with respect to the z-direction, but also with respect to the center M′ of the cell separating element 10, which is defined with respect to the y-direction.

In the present examples, the respective regions B1, B2, B3, B2′, B3′ each have a rectangular geometry or rectangular frame geometry in the top view of the illustrated x-direction. This does not necessarily have to be the case, as illustrated in FIG. 8 and FIG. 9. FIG. 8 shows, for example, a cell separating element 10 with a first region B1, which in turn is framed by the second region B2, wherein the first region B1 has a round or oval geometry. The second region B2 directly adjoins the first region B1 both in the z-direction and in the y-direction, and has an inner contour corresponding to the outer contour of the first region B1.

According to the example shown in FIG. 9, the first region B1 has a geometry, in particular an outer contour, according to two overlapping circles or ellipses. The second region B2 is in turn directly adjacent to the first region B1 in the z-direction and in the y-direction and has a corresponding geometry of the inner contour.

These examples are merely intended to illustrate that there are numerous design and variation possibilities for the cell separating element with regard to its regions with different thicknesses and their geometries and arrangements relative to one another. So, many more design opportunities are conceivable. In particular, the examples given above can be combined with each other as desired. This provides particularly good adaptation properties of the cell separating element to the needs of a cell.

Overall, the examples show how the invention can provide a cell separating element with variably adjustable hardness regions. In general, the cell separating element comprises, for example, a material in different thicknesses and optionally also in different degrees of hardness and/or porosity or even different materials in certain regions. This allows the mechanical resistance to be variably adapted to the swelling behavior of the cell across the surface. This allows the cell to either be given targeted space for swelling or to be counteracted by a deliberately higher spring force or restoring force. A combination of the options mentioned above for adjusting the degree of hardness is also conceivable. This advantageously provides a cell separating element with the possibility of adjusting different force levels across the surface. A stiff region of the cell separating element, for example provided by a greater thickness in the uncompressed state, enables the transmission of higher forces, while a softer region with less resistance allows, for example, the cell to breathe in the region with stronger swelling behavior, for example a middle region. By varying the grain size of the granulate or the binder used as material components of the cell separating element, the hardness of the cell separating element can also be adjusted differently for specific regions. Possible materials include plastic granules or granules made from sustainable, renewable raw materials such as cork. In addition, the structure of the variable hardness range can also be provided via the porosity or adjusted in addition to varying thicknesses. A small porosity enables the transmission of higher forces, while a large porosity offers the cell less resistance in regions with stronger swelling behavior, for example. By varying the porosity of the foam, the hardness of the cell separating element can also be adjusted to suit specific regions. Instead of the porosity, the plastic used can also be varied or the plastic used can also be varied as a material for the different regions. Materials that can be considered here include plastic foams, such as polyurethane foams, or metal foams. In addition to plastic foams or other foams, (non-foamed) elastic materials can also be considered as an additional or alternative option. As described, the hardness of the cell separating element can be specifically adjusted for different regions within the 10 cell separating element by varying the initial thicknesses, i.e. the thicknesses in the different regions of the cell separating element in the uncompressed state.

1. A cell separating element for arrangement between two battery cells of a battery module,
wherein the cell separating element is designed as a solid body and has two outer sides opposite one another with respect to a first direction, the distance of which in the first direction defines a thickness of the cell separating element,
wherein the cell separating element is divided into at least one first and at least one second region in a second direction perpendicular to the first direction,
wherein the cell separating element is elastically compressible in at least one first region and in at least one second region with respect to the first direction,
wherein in an uncompressed state of the cell separating element, a maximum first thickness of the cell separating element in at least one first region and a maximum second thickness of the cell separating element in at least one second region are different, and
in a state of the cell separating element in which the at least one first region and the at least one second region are compressed to an equal maximum thickness with respect to the first direction, the restoring forces caused by the compression of the cell separating element in the at least one first region and in the at least one second region are different.

2. The cell separating element according to claim 1, wherein the thickness of the cell separating element varies stepwise in the second direction in the uncompressed state of the cell separating element.

3. The cell separating element according to claim 1, wherein the thickness of the cell separating element varies continuously in the second direction in the uncompressed state of the cell separating element.

4. The cell separating element according to claim 1, wherein in the uncompressed state of the cell separating element, the thickness of the cell separating element in the second direction is symmetrical with respect to a center of the cell separating element defined with respect to the second direction.

5. The cell separating element according to claim 1, wherein in the uncompressed state of the cell separating element, the thickness of the cell separating element varies in a third direction perpendicular to the first direction and the second direction, in particular symmetrically with respect to the center of the cell separating element defined in the third direction.

6. The cell separating element according to claim 1, wherein the at least one first region and the at least one second region of the cell separating element are formed from the same material with the same material properties, in particular
comprising a plastic material, in particular a plastic foam; and/or
comprising a metal foam; and/or
comprising a cork.

7. The cell separating element according to claim 1, wherein the at least one first region and the at least one second region of the cell separating element are formed from the same material with at least one different material property, in particular
comprising a foam having a different porosity than the at least one different material property,
comprising a granulate, in particular a cork granulate and/or plastic granulate, with a different grain size as the at least one different material property.

8. The cell separating element according to claim 1, wherein the at least one first region and the at least one second region of the cell separating element are formed from the same material with at least one different material property.

9. A battery module with a cell separating element according to claim 1, and with at least the two battery cells between which the cell separating element is arranged.

10. A method for producing a battery module according to claim 9,
characterized in that
the cell separating element is arranged between the two battery cells in such a way that the cell separating element is compressed with respect to the first direction such that the respective restoring forces caused by the compression of the cell separating element in the at least one first region and in the at least one second region are different.

11. The cell separating element according to claim 2, wherein the thickness of the cell separating element varies continuously in the second direction in the uncompressed state of the cell separating element.

12. The cell separating element according to claim 2, wherein in the uncompressed state of the cell separating element, the thickness of the cell separating element in the second direction is symmetrical with respect to a center of the cell separating element defined with respect to the second direction.

13. The cell separating element according to claim 3, wherein in the uncompressed state of the cell separating element, the thickness of the cell separating element in the second direction is symmetrical with respect to a center of the cell separating element defined with respect to the second direction.

14. The cell separating element according to claim 2, wherein in the uncompressed state of the cell separating element, the thickness of the cell separating element varies in a third direction perpendicular to the first direction and the second direction, in particular symmetrically with respect to the center of the cell separating element defined in the third direction.

15. The cell separating element according to claim 3, wherein in the uncompressed state of the cell separating element, the thickness of the cell separating element varies in a third direction perpendicular to the first direction and the second direction, in particular symmetrically with respect to the center of the cell separating element defined in the third direction.

16. The cell separating element according to claim 4, wherein in the uncompressed state of the cell separating element, the thickness of the cell separating element varies in a third direction perpendicular to the first direction and the second direction, in particular symmetrically with respect to the center of the cell separating element defined in the third direction.

17. The cell separating element according to claim 2, wherein the at least one first region and the at least one second region of the cell separating element are formed from the same material with the same material properties, in particular
comprising a plastic material, in particular a plastic foam; and/or
comprising a metal foam; and/or
comprising a cork.

18. The cell separating element according to claim 3, wherein the at least one first region and the at least one second region of the cell separating element are formed from the same material with the same material properties, in particular
comprising a plastic material, in particular a plastic foam; and/or
comprising a metal foam; and/or
comprising a cork.

19. The cell separating element according to claim 4, wherein the at least one first region and the at least one second region of the cell separating element are formed from the same material with the same material properties, in particular
comprising a plastic material, in particular a plastic foam; and/or
comprising a metal foam; and/or
comprising a cork.

20. The cell separating element according to claim 5, wherein the at least one first region and the at least one second region of the cell separating element are formed from the same material with the same material properties, in particular
comprising a plastic material, in particular a plastic foam; and/or
comprising a metal foam; and/or
comprising a cork.
